(19) United States
(12) Patent Application Publication
(10) Pub. No.: US 2014/0224948 A1
(43) Pub. Date: Aug. 14, 2014

(54) Stand For A Guitar

(71) Applicant: Charles McEwan, (US)

(72) Inventor: Charles McEwan, Kirkcowan (GB)

(21) Appl. No.: 14/174,859

(22) Filed: Feb. 7, 2014

(30) Foreign Application Priority Data
Feb. 13, 2013 (GB) 1302473.2

(51) Int. Cl. G10G 5/00

(52) U.S. Cl. CPC G10G 5/00
USPC 248/163.1; 248/176.1

(57) ABSTRACT

A stand 10 for a guitar 100 comprises a support member 18, ground engaging means 16 depending from the support member 18, engagement means 22 for engaging with a strap button 102 of a guitar 100 to be supported, and resilient support means 14 provided on either side of the engagement means 22.

### BACKGROUND TO THE INVENTION

It is known to provide stands and hangers for guitars, which are used to support a guitar safely, whilst not in use. A hanger is generally used for storage of a guitar against a wall or other structure.

A stand for a guitar can be used, both for storage, but also when the guitar is being played, either in practice, in performances or in performance rehearsals. When playing a guitar, it is common to place the guitar on a stand for a period of time, for example, when there is a break in the music. The general construction of a guitar stand comprises a plurality of legs, either two or usually three; a back support extending upwardly from the legs and a pair of support members extending either from the back support or the legs for supporting the body of the guitar. The support members are often parallel with one another and extend across the full body of the guitar. The higher quality stands also have up-stands at the ends of the support members, in an attempt to prevent a guitar from being knocked off the stand.

Even so, in use, a guitar is simply rested on the guitar stand with the body of the guitar being supported on the support members and the back of the body of the guitar resting against the back support. The back support is generally provided at an angle to the vertical, so that the neck of the guitar points upwardly at an angle. If the guitar is knocked sideways or forwards whilst resting on the stand, it may well fall from the stand, possibly damaging the guitar.

It is an object of the invention to provide an improved guitar stand which reduces or substantially mitigates these problems.

### STATEMENT OF INVENTION

According to the present invention there is provided a stand for a guitar comprising a support member, ground engaging means depending from the support member, engagement means for engaging with a strap button of a guitar to be supported, and resilient support means provided on either side of the engagement means.

The engagement means hold the guitar to the support member. If the guitar is knocked, then it will not become detached from the support member. The resilient support means urge the body of the guitar away from the support member whilst the strap button of the guitar is fixed within the engaging means. This ensures that the guitar is securely engaged to the stand by increasing the friction between the engaging means and the strap button of the guitar.

The ground engaging means provide the stand with a stable base, making the stand unlikely to be knocked over. The ground engaging means may in some cases be fixed to the ground, providing further security for the guitar.

The ground engaging means may be provided by a plurality of legs. The legs may be spread out to create a wide stable base for the guitar. The legs may be removably mounted to the support member, so that the stand may be easily disassembled for portability.

The resilient support means may include springs. The springs urge the guitar away from the support member, increasing the friction between the engaging means and the strap button of the guitar.

The springs may be leaf springs, and may extend from the sides of the support member. The support member may include V-shaped side sections extending from either side of a central section, the engagement means being provided on the central section. The central and side sections of the support member may be formed integrally as a single piece.

An integral support member as described above is simple and economical to manufacture. The V-shaped side sections extending from the central section provide a structure which in use is below the point where the guitar rests on the stand. The springs may be supported from the V-shaped side sections below the guitar, so that the guitar may be pushed against the springs towards the support member, the guitar when resting on or just above the support member being subject to an upward force from the springs.

The springs may be attached to the side sections by screws, rivets, or the like. The springs may overlap the side sections, the springs being disposed adjacent to either the upper or the lower surface of the side sections. Advantageously, the springs may be removably attachable to the side sections so that they can be moved between an attachment point adjacent the upper surface of the side section and an attachment point adjacent the lower surface of the side section. Moving the spring between these attachment points slightly adjusts the position of the spring, and the resilience of the overall assembly. It therefore allows adjustment of the stand to suit a particular shape of guitar.

As an alternative to V-shaped side sections, planar side members may extend from either side of the central section, extending both downwardly below the central section and inwardly towards each other. The springs may then be attached to the planar side members, a portion of each spring extending inwardly below the central section and a portion of each spring extending outwardly above the central section.

The engagement means may comprise a keyhole aperture in the support member. A keyhole aperture includes a wide aperture section and a narrow aperture section. A guitar strap button has a wide part at a distal end, and is narrower close to the guitar body. The guitar strap button may therefore be passed through the wide aperture section, and then slid into the narrow aperture section. The wide part of the guitar strap button cannot pass through the narrow aperture section, so the guitar is effectively locked in place. Where the guitar is urged away from the support member by the resilient support means, the friction between the guitar strap button and the keyhole aperture prevents the guitar from sliding out of the keyhole fastening.

As an alternative to a keyhole aperture, an adjustable size aperture may be provided. For example, a wide aperture may be provided with a narrow closure member which slides over the wide aperture and locks on to the guitar strap button, thus preventing the guitar from being detached from the support member. The narrow closure may be spring loaded so that it automatically slides over the aperture when it is not being positively pulled away. A guitar strap button may be introduced through the aperture, and the aperture may then be reduced in size to retain the guitar in the aperture.

Standoffs may be provided on the support member, to limit how far the guitar can be pushed towards the support member and for spacing the guitar from the support member when the guitar is resting on the stand. The standoffs may be made from a soft material, for example rubber or plastic, to protect the base of the guitar from damage when it touches the standoffs. The standoffs may be nylon screws.

As well as preventing damage, the standoffs help to reduce any bouncing effect if the guitar is pushed vigorously sideways while being held by the stand.

The standoffs may be adjustable for adjusting the space between the guitar and the support member. This is advantageous for accommodating guitars with differently shaped bodies, and/or strap buttons of different lengths.

### BRIEF DESCRIPTION OF THE DRAWINGS

For a better understanding of the present invention, and to show more clearly how it may be carried into effect, reference will now be made, by way of example only, to the accompanying drawings, in which:

FIG. 1 shows a perspective view of an acoustic guitar supported on a guitar stand of the invention;

FIG. 2 shows an underside perspective view of an acoustic guitar being placed on the guitar stand of FIG. 1;

FIG. 3 shows an underside perspective view of an acoustic guitar fully located and supported by a the guitar stand of Figure I ;

FIG. 4 shows a perspective view of the guitar stand of FIG. 1; and

FIG. 5 shows a perspective view of the guitar stand of FIG. 1 with the legs removed for storage.

### DESCRIPTION OF PREFERRED EMBODIMENTS

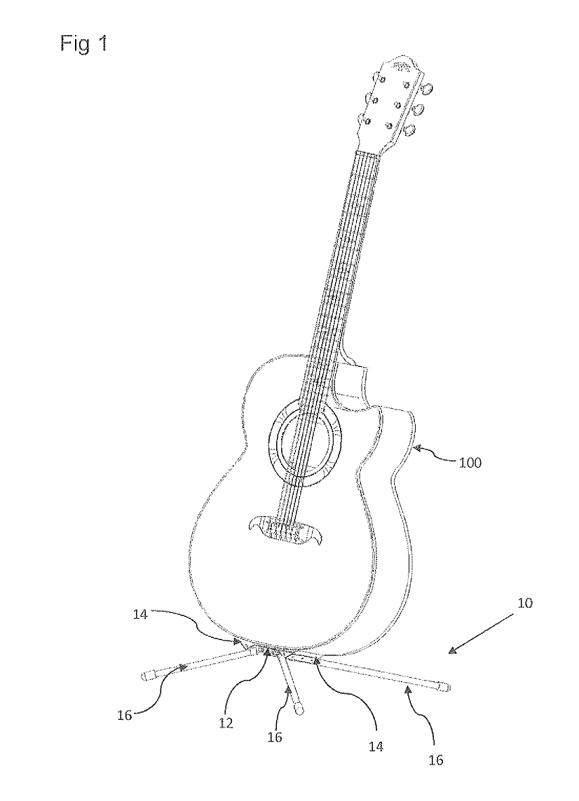

Referring firstly to FIG. 1, a guitar stand is indicated generally at 10, supporting guitar 100. The guitar stand includes a support member 12, sprung bearing members 14 and four legs 16 (three shown in FIG. 1).

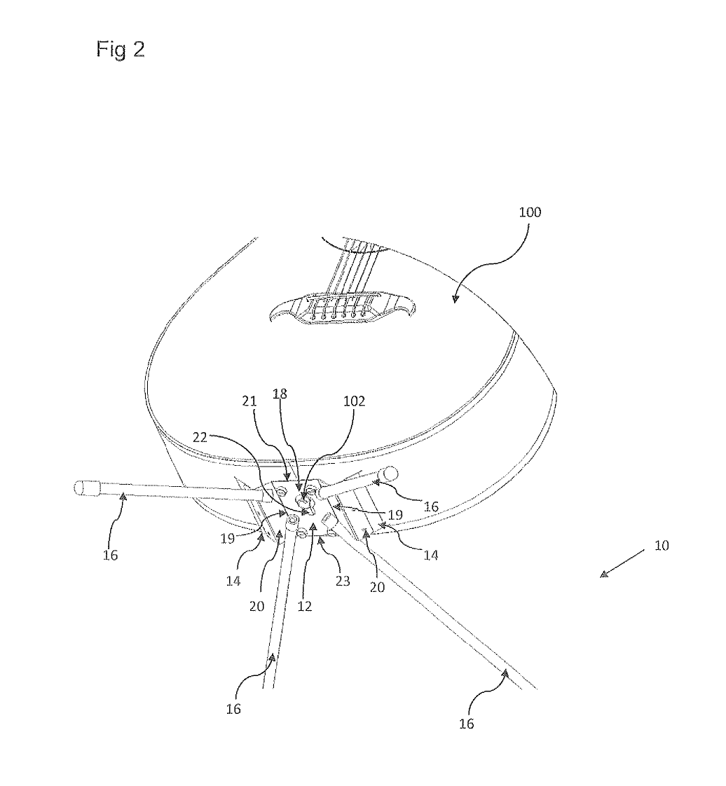

The guitar stand 10 is seen more clearly in FIG. 2. The support member 12 is formed of a central section 18, and two V-shaped side sections 20. The central section 18 is substantially planar and is rectangular, having two sides 19, a front edge 21 and a rear edge 23. The side sections 20 extend downwardly at an angle from either side 19 of the central section 18, and then upwardly and away from the central section 18. The spring bearing members 14 are made from spring steel or another suitable material which retains its resilience over time, and are fixed to the upwardly extending part of each side section 20. The sprung bearing members 14 form a continuation of the upwardly extending part of the side sections 20, extending above the level of the planar central section 18. In the drawings, the sprung bearing members have lower surfaces which are disposed adjacent the upper surfaces of the side sections 20. However, the sprung bearing members 14 are removably attached to the side sections 20, and may equally be attached with their lower surfaces adjacent the lower surfaces of the side sections 20.

The side sections 20 of the support member are formed integrally with the central section 18. The support member as a whole is pressed from stainless steel or made from another material which is suitably rigid to provide a firm foundation for the leaf springs. The V-shaped side sections 20, working with the sprung bearing members 14, provide resilience to provide an upward force on the guitar.

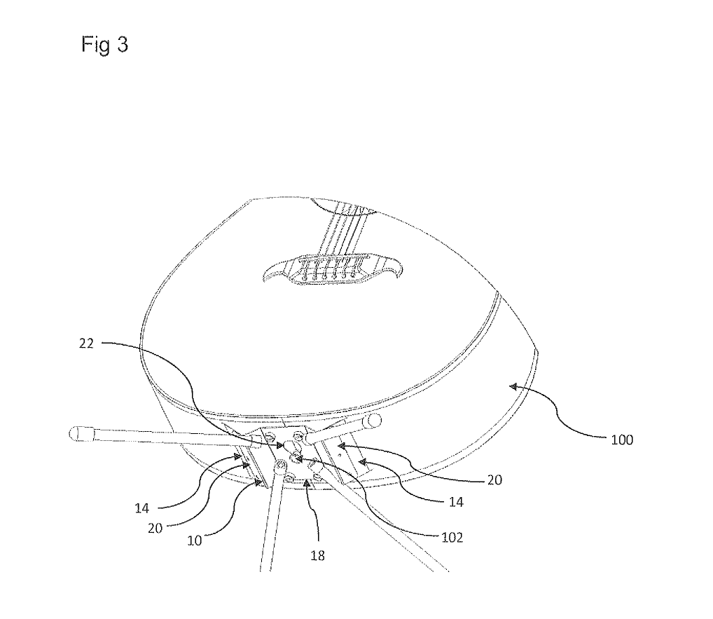

A guitar engagement fixture 22 is provided on the central section 18 of the support member 12. The fixture 22 is a keyhole aperture, having a wide section and a narrow section. The elongate axis of the keyhole aperture is parallel with and centrally disposed between the two sides 19 of the central section 18. The fixture 22 engages with a strap button 102 of a guitar 100. The strap button 102, is wide at its distal end, and narrow close to the guitar body. The strap button 102 may therefore fit through the wide section of fixture 22, and slide into the narrow section, but may not pass through the narrow section. FIG. 2 shows a guitar being placed on the stand, with the strap button 102 through the wide section of fixture 22. FIG. 3 shows the guitar fixed to the stand, strap button 102 having been slid into the narrow section of the fixture 22.

When the guitar is fixed to the stand, as shown in FIG. 3, the sprung bearing members 14 act on the guitar 100, pushing the guitar 100 away from the stand 10.

There is also a certain amount of resilience provided by the V-shaped side sections 20. The force on the guitar increases the friction between the strap button 102 and the central section 18 of the support member 12, preventing the guitar from easily sliding in the fixture 22. When it is desired to remove the guitar 100 from the stand 10, the guitar 100 may be pushed down, towards the stand 10, and then slid in the fixture 22 to release the guitar 100 from the stand 10.

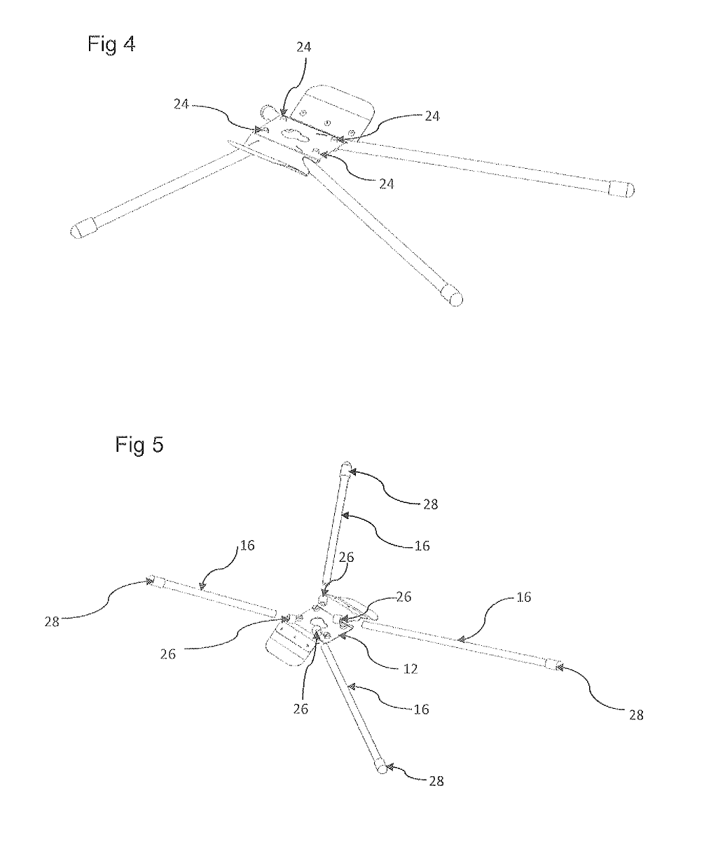

Referring now to FIG. 4, four standoffs 24 are provided, one at each corner of the central section 20 of the support member 12. The standoffs 24 are made from a soft resilient material, such as plastic, rubber, or nylon, to ensure that the guitar body is not damaged by contact with the standoffs, and to keep the guitar spaced from the stand. The standoffs limit how far the guitar may be pushed down and prevent a bouncing effect against the sprung bearing. The standoffs are screw threaded, and pass through threaded holes in the support member 12 from the underside. As seen in FIG. 2, the standoffs have screw heads for adjusting the spacing of a guitar from the support member.

Referring now to FIG. 5, the legs 16 are attached to the support member 12 via screw threaded sockets fixed to the support member 12. The legs 16 may therefore be easily detached from the support member 12, disassembling the guitar stand 10 for easy storage.

The legs 16 have plastic or rubber feet 28, to provide a grip for the stand, and to protect the surface of the floor from damage.

In use, the legs 16 rest on the ground, holding the support member 12 spaced from the ground. The guitar 100 is held securely to the support member 12. The guitar is securely attached to the stand and is not easily dislodged, but is nevertheless easily and quickly removable when required.

1. A stand for a guitar comprising a support member, ground engaging means depending from the support member, engagement means for engaging with a strap button of a guitar to be supported, and resilient support means provided on either side of the engagement means.

2. A stand for a guitar as claimed in claim 1, in which the ground engaging means is provided by a plurality of legs.

3. A stand for a guitar as claimed in claim 2, in which the legs are removably mounted to the support member.

4. A stand for a guitar as claimed in claim 1, in which the resilient support means includes springs.

5. A stand for a guitar as claimed in claim 4, in which the springs are leaf springs extending from the sides of the support member.

6. A stand for a guitar as claimed in claim 5, in which the support member includes V-shaped side sections extending from either side of a central section, the engagement means being provided on the central section.

7. A stand for a guitar as claimed in claim 6, in which the central and side sections of the support member are formed integrally as a single piece.

8. A stand for a guitar as claimed in claim 7, in which the springs are removably attachable to the side members in a first attachment position in which a surface of each spring abuts an upper surface of each side section and in a second attachment position in which a surface of each spring abuts a lower surface of each side section.

9. A stand for a guitar as claimed in claim 7, in which the support member is folded from sheet metal.

10. A stand for a guitar as claimed in claim 1, in which the engagement means comprises a keyhole aperture in the support member.

11. A stand for a guitar as claimed in claim 1, in which standoffs are provided on the support member, for spacing the guitar from the support member.

12. A stand for a guitar as claimed in claim 11, in which the standoffs are adjustable for adjusting the space between the guitar and the support member.
